(19) United States
(12) Patent Application Publication
(10) Pub. No.: US 2018/0216029 A1
(43) Pub. Date: Aug. 2, 2018

(54) CONCENTRATED SURFACTANT COMPOSITION

(71) Applicant: The Procter & Gamble Company, Cincinnati, OH (US)

(72) Inventors: Douglas James WILDEMUTH, Cincinnati, OH (US); Jeffrey Frank OMNITZ, Cincinnati, OH (US); Nicole Lee ARLEDGE, Independence, KY (US); Patrick Christopher STENGER, Fairfield, OH (US); Scott William CAPECI, North Bend, OH (US)

(21) Appl. No.: 15/417,249

(22) Filed: Jan. 27, 2017

(51) Int. Cl. C11D 1/22; C11D 1/29; C11D 1/66; C11D 3/37; C11D 3/43; C11D 3/20; C11D 1/75; C11D 11/00

(52) U.S. Cl. CPC C11D 1/22; C11D 1/29; C11D 1/66; C11D 11/0017; C11D 3/43; C11D 3/2068; C11D 1/75; C11D 3/3723

(57) ABSTRACT

Concentrated surfactant compositions that include an alkyl alkoxylated sulfate surfactant and an alkoxylated polyalkyleneimine, and process for making such compositions. Detergent compositions made from such concentrated surfactant compositions, and process for making such detergent compositions.

### FIELD OF THE INVENTION

The present disclosure relates to concentrated surfactant compositions that include an alkyl alkoxylated sulfate surfactant and an alkoxylated polyalkyleneimine, and process for making such compositions. The present disclosure further relates to detergent compositions made from such concentrated surfactant compositions, and process for making such detergent compositions.

### BACKGROUND OF THE INVENTION

Concentrated surfactant compositions are useful for making detergent compositions, such as laundry or dish detergent compositions. Because they have high activity, they can be transported relatively efficiently. Furthermore, they can be combined and diluted with other detergent ingredients or carriers to arrive at a desired level of activity.

However, concentrated surfactant compositions, particularly those that contain a high proportion of anionic alkyl alkoxylated sulfate surfactant, may also present viscosity and/or stability challenges. The viscosity of such compositions may be relatively high, making the compositions difficult to pump or drain, for example from a rail car or from a storage tank to a manufacturing line. The compositions may also suffer from phase splits, which can lead to inconsistencies in the final product and/or aesthetic problems. Even upon dilution with water, concentrated compositions that include anionic alkyl alkoxylated sulfate surfactant may form a highly viscous hexagonal phase, which can be very challenging to process.

To counteract viscosity and/or stability issues, organic solvents may be added to the concentrated surfactant compositions. However, organic solvents may add cost without providing much performance benefit in the final product.

There is a need for improved concentrated surfactant compositions that have a relatively high level of activity, limited solvents levels, and desirable viscosity and/or phase stability.

### SUMMARY OF THE INVENTION

The present disclosure relates to concentrated surfactant compositions that include alkyl alkoxylated sulfate surfactant and an alkoxylated polyalkyleneimine polymer.

More specifically, the present disclosure relates to a concentrated surfactant composition consisting essentially of: from about 60% to about 69%, by weight of the composition of a surfactant system, wherein the surfactant system comprises from about 70% to about 100%, by weight of the surfactant system of an alkyl alkoxylated sulfate surfactant; from about 0.1% to about 5%, by weight of the composition, of an alkoxylated polyalkyleneimine; less than about 10%, by weight of the composition, of an organic solvent system; and water.

The present disclosure also relates to a detergent composition that includes a concentrated surfactant composition as described herein, and a detergent adjunct.

The present disclosure also relates to a process for manufacturing a concentrated surfactant composition, where the process includes the steps of: providing an alkyl alkoxylated sulfate surfactant, an alkoxylated polyalkyleneimine, preferably an alkoxylated polyethyleneimine (PEI), an organic solvent system, and water; and combining the components in the following proportions to form the concentrated surfactant composition: from about 60% to about 69%, by weight of the composition, of the alkyl alkoxylated sulfate surfactant; from about 0.1% to about 5%, by weight of the composition, of the alkoxylated polyalkyleneimine; less than about 10%, by weight of the composition, of the organic solvent system; and water.

The present disclosure also relates to a process for manufacturing a detergent composition, the process comprising the steps of: providing a concentrated surfactant composition as described herein; and combining the concentrated surfactant composition with a detergent adjunct to form the detergent composition.

The present disclosure also relates to a use of an alkoxylated polyalkyleneimine, preferably an alkoxylated PEI, for reducing viscosity of a concentrated surfactant composition, where the composition includes from about 60% to about 69%, by weight of the composition, of an alkyl alkoxylated sulfate surfactant.

### DETAILED DESCRIPTION OF THE INVENTION

The present disclosure relates to concentrated surfactant compositions that contain a relatively high level of alkyl alkoxylated sulfate surfactant, such as alkyl ethoxylated sulfate surfactant (“AES”). Lamellar phase AES pastes are traditionally used due to their relatively stable phase profile. However, as the activity of these pastes increases to 60% and above, the rheology profiles of the pastes tend to increase significantly.

While organic solvents can be added to improve the viscosity and/or stability of the concentrated compositions, solvents typically add cost to a composition without adding performance benefits to final compositions. Furthermore, too much solvent can also lead to stability challenges when insufficient amounts of water are present.

Phase stability knowledge of AES molecules shows a hexagonal phase that forms at levels of about 30-60%, by weight of the composition, and a lamellar phase that forms above about 60% in the absence of solvent. Hexagonal phases are typically characterized by high viscosities and near-solid behavior, while lamellar phases are typically viscous but flowable. However, even the flowable lamellar phase rheology profiles may not be conducive to all transportation options, such as rail cars. It is desirable to be able to modify the rheology of these lamellar paste phases without impacting the cost of the material when used in product or negatively impacting the stability of the concentrated compositions.

The compositions of the present disclosure may include alkyl alkoxylated sulfate surfactant at levels near the top range of what is traditionally in the hexagonal phase, while still being flowable. The target viscosity of the present compositions may be even lower than is typical for lamellar phase AES compositions. The present compositions may have a viscosity of equal to or less than about 20,000 cps, or less than about 15,000 cps at 1 s⁻¹ at 40° C. (1000 cps=1 Pa·s).

It has been surprisingly found that alkoxylated alkyleneimine polymers, such as alkoxylated polyethyleneimines (PEIs), can be added to the concentrated composition to provide viscosity and/or stability benefits, thereby enabling the level of organic solvent to be decreased. Such polymers are commonly used in final products, such as laundry detergents, in combination with AES and provide more performance benefits, such as cleaning benefits, than organic solvents do. Spiking the concentrated compositions, which may be upstream in the manufacturing process, with these polymers enables the final product's activity level to remain relatively high without sacrificing formulation space or paying unnecessary cost.

The components and properties of the concentrated surfactant compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein with regard to surfactants that may have an acid form, “neutralized” means that the surfactant is in salt form, such as a sodium salt. As used herein with regard to surfactants that may have an acid form, “preneutralized” means that the surfactant is in salt form prior to being combined with at least one other component of the disclosed compositions. The pH of such (pre)neutralized surfactants in a 10% aqueous solution may be about 7 or above.

As used herein, “isotropic” means a clear mixture (having no visible haziness and/or dispersed particles) and having a uniform transparent appearance. For example, the compositions of the present disclosure may be characterized by a % transmittance of greater than about 80%, or greater than about 90%, at a wavelength of 570 nm measured at room temperature via a standard 10 mm pathlength cuvette with a Beckman DU spectrophotometer using deionized water as blank, in the absence of dyes and/or opacifiers.

As used herein, the term “alkoxy” is intended to include C1-C8 alkoxy and C1-C8 alkoxy derivatives of polyols having repeating units such as butylene oxide, glycidol oxide, ethylene oxide or propylene oxide. The terms “ethylene oxide,” “propylene oxide” and “butylene oxide” may be shown herein by their typical designation of “EO,” “PO” and “BO,” respectively.

As used herein “average molecular weight” is reported as a weight average molecular weight, as determined by its molecular weight distribution; as a consequence of their manufacturing process, polymers disclosed herein may contain a distribution of repeating units in their polymeric moiety.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Concentrated Surfactant Composition

The present disclosure relates to concentrated surfactant compositions. The compositions described herein may be intermediate compositions intended to be combined with other ingredients to form a final product. The concentrated surfactant compositions of the present disclosures are sometimes considered to be surfactant pastes.

The concentrated surfactant compositions may comprise, may consist essentially of, or may consist of the following components: a surfactant system that may include an alkyl alkoxylated sulfate surfactant; an alkoxylated polyalkyleneimine; an organic solvent system; and water. These components are described in more detail below.

The concentrated surfactant composition may comprise: from about 60% to about 69%, by weight of the composition, of a surfactant system, where the surfactant system comprises from about 70%, or from about 80%, or from about 90%, or from about 95%, to about 100%, of alkyl alkoxylated sulfate surfactant; from about 0.1% to about 5%, by weight of the composition, of an alkoxylated polyethyleneimine (PEI); less than about 10%, by weight of the composition, of an organic solvent system; and water. The composition may comprise no more than 2, or no more than 1, additional ingredients.

The concentrated surfactant composition may be in the form of a liquid, gel, and/or paste. Typically, the concentrated surfactant composition is not a solid composition, such as a granular or powdered composition. The concentrated surfactant composition may be non-particulate.

The concentrated surfactant compositions may have a viscosity of less than about 20,000 cps, or less than about 15,000 cps, or less than about 10,000 cps, or less than about 7,000 cps, measured at 1 s⁻¹ and 40° C. The concentrated surfactant compositions may have a viscosity of from about 100 cps, or from about 500 cps, or from about 1000 cps, to about 20,000 cps, or to about 15,000 cps, or to about 10,000 cps, or to about 7000 cps, measured at 1 s⁻¹ and 40° C. Having a relatively low viscosity may facilitate transporting, pumping, and/or processing the compositions. For example, viscosity of the concentrated composition may influence whether the composition is pumped out of a rail car via the top or bottom of the car.

It may be desirable for the concentrated surfactant composition to be phase stable and/or have a clear appearance, as such compositions may be easier to process and/or incorporate into a final product. The concentrated surfactant composition may be isotropic, which can be indicative of the composition being phase stable. The concentrated surfactant composition may remain as a single phase, isotropic solution after 2 weeks at 20° C., and/or 2 weeks at 40° C. The concentrated surfactant composition may have a percent transmittance (% T) at 570 nm of at least about 80%, or of at least about 85%, or of at least about 90%, or of at least about 95%, or of at least about 98%, or of at least about 99%. Percent transmittance is determined according to the Percent Transmittance method provided in the Test Methods section below.

The concentrated surfactant composition may have an alkaline pH in a 10% (weight/volume) solution of the composition at 20±2° C. The concentrated surfactant composition may be characterized by a pH greater than 8, or greater than 9, or greater than 10, or greater than 11, in a 10% (weight/volume) solution of the composition at 20±2° C. The concentrated surfactant composition may have a pH of from about 9 to about 13, or preferably from about 10 to about 13, in a 10% (weight/volume) solution of the composition at 20±2° C.

The concentrated surfactant composition may be characterized by a Reserve Alkalinity (RA) value. RA is a measure of the buffering capacity of the detergent composition (g/NaOH/100 g detergent composition) determined by titrating a 1% (w/v) solution of detergent composition with hydrochloric acid to pH 7.5 and is determined according to the method provided in the Test Methods section below. The concentrated surfactant composition may be characterized by a Reserve Alkalinity of less than about 2, or less than about 1.5, or less than about 1, or less than about 0.8. The concentrated surfactant composition may be characterized by a Reserve Alkalinity of from about 0.1, or from about 0.3, or from about 0.5, to about 2.0, or to about 1.5, or to about 1.0, or to about 0.8. Such Reserve Alkalinity can help to maintain the alkaline pH of the compositions described herein. Because alkyl alkoxylated sulfate surfactants can undergo acid-catalyzed hydrolysis reactions in acidic environments, it can be particularly desirable for compositions comprising such surfactants to have a certain Reserve Alkalinity.

### Surfactant System

The concentrated surfactant compositions of the present disclosure comprise a surfactant system. The concentrated surfactant compositions may comprise from about 60% to about 69%, by weight of the composition, of a surfactant system.

The surfactant system may comprise anionic surfactant. The anionic surfactant of the surfactant system may comprise, or consist essentially of, alkyl alkoxylated sulfate surfactant, linear alkyl benzene sulfonate surfactant, or mixtures thereof. The surfactant system may be substantially free of nonionic surfactant, cationic surfactant, amphoteric surfactant, and/or zwitterionic surfactant. The surfactant system may be substantially free of nonionic surfactant.

The surfactant system may consist essentially of no more than two types of surfactants. It is recognized, however, that the surfactant system may include minor portions of, for example, raw material inputs, hydrolyzed reaction products, or other impurities related to the surfactants making up the major portion of the surfactant system, or other impurities.

The surfactants present in the surfactant system may be present either partially or completely in acid form or as a salt, typically a water-soluble salt. Suitable counterions include alkali metal cation, typically sodium, or ammonium or substituted ammonium, typically sodium. The surfactants, either separately or together, may be preneutralized prior to being combined with one or more of the other components of the concentrated surfactant system.

Alkyl Alkoxylated Sulfate

The surfactant system may comprise alkyl alkoxylated sulfate surfactant. The alkyl alkoxylated surfactant may be the major portion of the surfactant system. The alkyl alkoxylated surfactant may be linear, branched, or combinations thereof.

The alkyl alkoxylated sulfate surfactant may be present at a level of from about 60% to about 69%, by weight of the composition.

The alkyl alkoxylated sulfate surfactant may be an alkyl ethoxylated sulfate surfactant, an alkyl propoxylated surfactant, or mixtures thereof, preferably an alkyl ethoxylated sulfate surfactant. The alkyl alkoxylated sulfate surfactant may have a weight average degree of alkoxylation, preferably ethoxylation of from about 1 to about 3.5, more preferably from about 1.5 to about 3, even more preferably from about 1.8 to about 2.5.

When the alkyl alkoxylated sulfate surfactant is a mixture of alkyl alkoxylated sulfate surfactant, the alkoxylation degree is the weight average alkoxylation degree of all the components of the mixture (weight average alkoxylation degree). In the weight average alkoxylation degree calculation the weight of alkyl alkoxylated sulfate surfactant components not having alkoxylated groups should also be included. Weight average alkoxyylation degree is calculated in the following manner:

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

The alkyl alkoxylated sulfate surfactant may be alkyl ethoxylated surfactant having a narrow range of ethoxylation. The alkyl ethoxylated surfactant may include a distribution of alkyl ethoxylated surfactants where less than about 7% by weight of the total alkyl ethoxylated surfactant are alkyl ethoxylated surfactant having n>3 and less than about 35% by weight of the total alkyl ethoxylated surfactant are alkyl ethoxylated surfactants having n=0, where n is the number of ethoxylates (EO) groups in the surfactant (AEₙS).

The alkyl alkoxylated sulfate may have a weight average alkyl chain length of from about 8 to about 18, or from about 10 to about 16 carbon atoms, preferably from about 12 to about 15 carbon atoms, even more preferably from about 14 to about 15 carbon atoms.

The alkyl alkoxylated sulfate may be alkyl ethoxylated surfactant having an average alkyl chain length of from about 14 to about 15 carbon atoms, and an average degree of ethoxylation of from about 2.3 to about 2.7, preferably about 2.5. The alkyl alkoxylated sulfate may be C45 AE_{2.5}S, which has a weight average alkyl chain length of from 14 to 15 carbons and a weight average ethoxylation degree of 2.5.

If the alkyl alkoxylated sulfate is a branched alkyl alkoxylated sulfate, the branching group may be an alkyl. The alkyl may be selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. The branched alkyl alkoxylated sulfated anionic surfactant may be an alkyl ethoxy sulfates.

Alkyl alkoxylated sulfate surfactants are commercially available with a variety of chain lengths, ethoxylation and branching degrees. Commercially available sulfates include, those based on Neodol alcohols ex the Shell company, Lial—Isalchem and Safol ex the Sasol company, natural alcohols ex The Procter & Gamble Chemicals company.

Linear Alkyl Benzene Sulfonate

The composition or surfactant system may comprise linear alkyl benzene sulfonate surfactant (LAS). The linear alkyl benzene sulfonate surfactant may present at a level of from about 0% to about 15%, or from about 2% to about 15%, or from about 5% to about 12%, by weight of the composition.

The linear alkyl benzene sulphonate surfactant has a weight average alkyl chain length of from about 10 to about 16, preferably from about 11 to about 13, carbon atoms. The weight average alkyl chain length of the LAS may be about 11.8 carbons. The LAS may be present in acid form or as a salt, preferably as a sodium salt.

The weight ratio of AES to LAS in the surfactant system may be in the range of from about 25:1 to about 1:1, or from about 20:1 to about 1.5:1, or from about 15:1 to about 3:1, or from about 10:1 to about 5:1, or from about 7:1 to about 6:1.

Suitable alkyl benzene sulphonate (LAS) is obtainable, and is preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as those catalyzed by hydrofluoric acid (HF), may also be suitable.

### Alkoxylated Polyalkyleneimine

The concentrated surfactant compositions of the present disclosure may comprise an alkoxylated polyalkyleneimine polymer. The alkoxylated polyalkylenimine may be present in the composition at a level of from about 0.1% to about 5%, or from about 0.5% to about 4.5%, preferably from about 0.75% to about 1.5%, by weight of the composition.

The alkxoylated polyalkylenimine may be linear, branched, or combinations thereof, preferably branched.

Typically, the alkoxylated polyalkyleneimine polymer comprises a polyalkyleneimine backbone. The polyalkyleneimine may comprise C2 alkyl groups, C3 alkyl groups, or mixtures thereof, preferably C2 alkyl groups. The alkoxylated polyalkyleneimine polymer may have a polyethyleneimine (“PEI”) backbone.

The alkoxylated PEI may comprise a polyethyleneimine backbone having a weight average molecular weight of from about 400 to about 1000, or from about 500 to about 750, or from about 550 to about 650, or about 600, as determined prior to ethoxylation.

The PEI backbones of the polymers described herein, prior to alkoxylation, may have the general empirical formula:

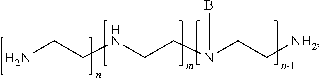

where B represents a continuation of this structure by branching. In some aspects, n+m is equal to or greater than 8, or 10, or 12, or 14, or 18, or 22.

The alkoxylated polyalkyleneimine polymer comprises alkoxylated nitrogen groups. The alkoxylated polyalkyleneimine polymer may independently comprise, on average per alkoxylated nitrogen, up to about 50, or up to about 40, or up to about 35, or up to about 30, or up to about 25, or up to about 20, alkoxylate groups. The alkoxylated polyalkyleneimine polymer may independently comprise, on average per alkoxylated nitrogen, at least about 5, or at least about 10, or at least about 15, or at least about 20, alkoxylate groups.

The alkoxylated polyalkyleneimine polymer, preferably alkoxylated PEI, may comprise ethoxylate (EO) groups, propoxylate (PO) groups, or combinations thereof. The alkoxylated polyalkyleneimine polymer, preferably alkoxylated PEI, may comprise ethoxylate (EO) groups. The alkoxylated polyalkyleneimine polymer, preferably alkoxylated PEI, may be free of propoxyate (PO) groups.

The alkoxylated polyalkyleneimine polymer, preferably alkoxylated PEI, may comprise on average per alkoxylated nitrogen, about 1-50 ethoxylate (EO) groups and about 0-5 propoxylate (PO) groups. The alkoxylated polyalkyleneimine polymer, preferably alkoxylated PEI, may comprise on average per alkoxylated nitrogen, about 1-50 ethoxylate (EO) groups and is free of propoxylate (PO) groups. The alkoxylated polyalkyleneimine polymer, preferably alkoxylated PEI, may comprise on average per alkoxylated nitrogen, about 10-30 ethoxylate (EO) groups, preferably about 15-25 ethoxylate (EO) groups.

Suitable alkoxylated polyalkylenimine polymers may include propoxylated polyalkylenimine (e.g., PEI) polymers. The propoxylated polyalkylenimine (e.g., PEI) polymers may also be ethoxylated. The propoxylated polyalkylenimine (e.g., PEI) polymers may have inner polyethylene oxide blocks and outer polypropylene oxide blocks, the degree of ethoxylation and the degree of propoxylation not going above or below specific limiting values. The ratio of polyethylene blocks to polypropylene blocks (n/p) may be from about 0.6, or from about 0.8, or from about 1, to a maximum of about 10, or a maximum of about 5, or a maximum of about 3. The n/p ratio may be about 2. The propoxylated polyalkyleneimines may have PEI backbones having molecular weights (prior to alkoxylation) of from about 200 g/mol to about 1200 g/mol, or from about 400 g/mol to about 800 g/mol, or about 600 g/mol. The molecular weight of the propoxylated polyalkyleneimines may be from about 8,000 to about 20,000 g/mol, or from about 10,000 to about 15,000 g/mol, or about 12,000 g/mol.

Suitable propoxylated polyalkylenimine polymers may include compounds of the following structure:

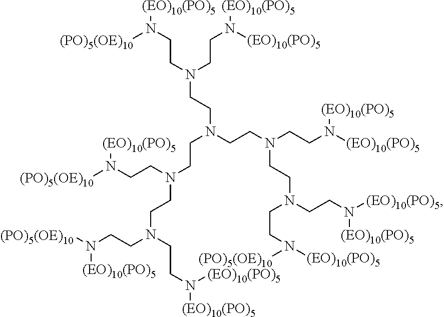

where EOs are ethoxylate groups and POs are propoxylate groups. The compound shown above is a PEI where the molar ratio of EO:PO is 10:5 (e.g., 2:1). Other similar, suitable compounds may include EO and PO groups present in a molar ratio of about 10:5 or about 24:16.

Suitable polyamines include low molecular weight, water soluble, and lightly alkoxylated ethoxylated/propoxylated polyalkyleneamine polymers. By “lightly alkoxylated,” it is meant the polymers of this invention average from about 0.5 to about 20, or from 0.5 to about 10, alkoxylations per nitrogen. The polyamines may be “substantially noncharged,” meaning that there are no more than about 2 positive charges for every about 40 nitrogens present in the backbone of the polyalkyleneamine polymer at pH 10, or at pH 7; it is recognized, however, that the charge density of the polymers may vary with pH.

Suitable alkoxylated polyalkyleneimines, such as PEI600 EO20, are available from BASF (Ludwigshafen, Germany).

### Organic Solvent System

The concentrated surfactant compositions of the present disclosure may comprise an organic solvent system. The organic solvent system may contribute to desirable viscosity and stability profiles in the compositions of the present disclosure. However, it may be desirable to keep the amount of solvent system as low as possible while still maintaining the desired viscosity and/or stability as the solvents add little to the performance benefits of the end product.

The organic solvent system may be present at a level of less than about 10%, or less than about 5%, or less than about 1%, by weight of the composition. The concentrated surfactant compositions may comprise from about 0% to about 10%, or from about 0% to about 5%, or from about 0% to about 1%, or about 0%, by weight of the composition, of an organic solvent system. The concentrated surfactant composition may be substantially free of an organic solvent system.

The organic solvent, if present, may comprise at least one, or at least two, or at least three organic solvents. The organic solvents system may comprise no more than four, or no more than three, or no more than two, or no more than one organic solvent.

The organic solvent system, if present, may comprise a solvent selected from the group consisting of monohydric alcohols such as ethanol, propanol, butanol, isopropanol; dihydric alcohols such as diethylene glycol, propanediol, butanediol and diols wherein the hydroxyl groups present in said diol are attached to adjacent atoms; polyalkylene glycols such as polyethylene glycol; polyhydric alcohols such as glycerine; alkoxylated glycerine, alkoxylated diols, and combinations thereof. The organic solvent system may comprise a solvent selected from the group consisting of: glycerine, ethanol, propanediol, diethylene glycol, dipropylene glycol, polyalkylene glycol (e.g., PEG4000), butanediol and combinations thereof.

The organic solvent system may comprise propanediol. The organic solvent system may comprise propanediol and at least one other organic solvent. The organic solvent system may comprise propanediol and diethylene glycol. The weight ratio of propanediol to diethylene glycol may be from about 1:2 to about 4:1. Alternatively, the organic solvent system may be substantially free of diethylene glycol.

The organic solvent system may comprise propanediol and ethanol. The weight ratio of propanediol to ethanol may be from about 1:1 to about 2.5:1, or from about 1.05:1 to about 2.11:1, or from about 1.5:1 to about 2.1:1.

The organic solvent system may be substantially free of amino-functional organic solvents.

### Water

The concentrated surfactant compositions of the present disclosure may contain water. The water can act as a solvent for the surfactant system in addition to the organic solvent system. When formulating the present concentrated compositions, some of the organic solvent system that might otherwise be necessary may be replaced by water. Water is typically present in at least some end detergent products, such as a heavy duty liquid detergent composition, and typically costs less than organic solvent.

The concentrated surfactant compositions of the present disclosure may contain the components described herein (including surfactant system, organic solvent system, and alkalizing agent), with water to balance. The concentrated surfactant compositions of the present disclosure may comprise from about 20%, or from about 25%, or from about 30%, or from about 34%, to about 40%, or to about 38%, or to about 36%, by weight of the composition, of water.

Water may be added as free or neat water. In some aspects, water enters the composition as a component of other ingredients, for example, as a carrier of sodium hydroxide or organic acid. It is understood that water may also be formed from the neutralization of acids in the composition, for example, from acid-form alkyl ethoxylated sulfate (HAES) or acid-form LAS (HLAS).

### Alkalizing Agent

The concentrated surfactant compositions of the present disclosure may comprise an alkalizing agent. The concentrated surfactant compositions may comprise from about 0.5% to about 5.5% of the alkalizing agent. The alkalizing agent may be present in the concentrated surfactant composition at a level sufficient to neutralize the surfactants. When the surfactants are neutralized, whether they enter the composition preneutralized or are neutralized by the addition of the alkalizing agent, a small amount of excess alkalizing agent may be present in the composition, for example, from about 0.1% to about 1% by weight of the concentrated surfactant composition.

The alkalizing agent may be a caustic agent. Suitable caustic agents include alkali metal hydroxides, alkali earth metal hydroxides, ammonium (substituted or unsubstituted) hydroxides, or mixtures thereof. The alkalizing agent may be an alkali metal hydroxide, preferably sodium hydroxide.

The alkalizing agent may be an alkanolamine, such as monoethanolamine (MEA) or triethanolamine (TEA).

### Other Components

The concentrated surfactant compositions described herein, while typically being limited in the number of ingredients, may include other components as suitable. Suitable components may include a polymer, an antimicrobial agent, other surfactants (including branched anionic surfactants and/or amine oxide), hydrotropes (such as sodium cumene sulfate), fatty acid and/or salts thereof, or mixtures of any of the foregoing. The concentrated surfactant compositions herein may be substantially free of fatty acids, preferably free of carboxylic acids, and/or their salts.

### Detergent Compositions

The concentrated surfactant compositions of the present disclosure are useful for making end-product detergent compositions intended to be sold to and used by consumers or institutions. Thus, the present disclosure also relates to detergent compositions. The detergent compositions of the present disclosure may comprise a concentrated surfactant composition, as described herein, and a detergent adjunct.

The detergent composition may have any form suitable for end use by a consumer, such as a liquid, a gel, a powder, a bar, a tablet, a unitized dose article such as a pouch (single- or multi-compartmented), a fiber, a web, or a sheet. The detergent composition may have a form selected from the group consisting of a liquid, a gel, or a paste. The detergent composition may be a fabric care composition. The detergent composition may be a liquid laundry detergent, a gel detergent, a liquid hand dishwashing composition, a laundry pretreat product, or mixtures thereof.

The detergent composition may comprise from about 18 to about 76%, by weight of the detergent composition, of the concentrated surfactant composition. The detergent composition may comprise a sufficient amount of the concentrated surfactant composition to provide about 10% to about 40%, by weight of the detergent composition, of surfactant to the detergent composition.

The detergent composition may comprise a detergent adjunct. Any suitable detergent adjunct may be added. The detergent adjunct may be selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

The detergent adjunct may comprise additional surfactant. Additional surfactants may be selected from anionic surfactants, nonionic surfactants, amphoteric surfactants, cationic surfactants, amphoteric surfactants, and combinations thereof. Suitable anionic surfactants may include additional LAS or branched anionic surfactants. Suitable nonionic surfactants may include ethoxylated alcohol surfactants. Suitable zwitterionic surfactants may include amine oxide.

### Process for Manufacturing a Concentrated Surfactant Composition

The present disclosure relates to a process for manufacturing the concentrated surfactant composition disclosed herein. The process may comprise the steps of: providing a surfactant system, an alkoxylated polyalkyleneimine, such as alkoxylated polyethyleneimine (PEI), an organic solvent system, and water; and combining the components in the following proportions to form the concentrated surfactant composition: from about 60% to about 69%, by weight of the composition, of an alkyl alkoxylated sulfate surfactant; from about 0.1% to about 5%, by weight of the composition, of the alkoxylated polyalkyleneimine; less than 10%, by weight of the composition, of the organic solvent system; and water.

The process may include providing the alkyl alkoxylated sulfate surfactant and/or the linear alklyl benzene sulphonate surfactant in preneutralized form, preferably preneutralized with sodium. The process may include the step of combining the alkyl alkoxylated sulfate surfactant and/or the linear alklyl benzene sulphonate surfactant with the alkalizing agent to preneutralize the surfactant(s) prior to combining with the organic solvent system. The composition may include a small excess of the alkalizing agent, preferably a caustic alkalizing agent such as sodium hydroxide, beyond what is required to neutralize the surfactants, whether or not they are provided as being preneutralized. Therefore, the concentrated surfactant composition may comprise from about 0.1% to about 1%, by weight of the concentrated surfactant composition, of an alkalizing agent, preferably a caustic alkalizing agent such as sodium hydroxide. It may be desirable to preneutralize the surfactants so that the pH can be more tightly controlled.

### Process for Manufacturing a Detergent Composition

The present disclosure relates to a process for manufacturing the detergent compositions. The detergent composition may have any form suitable for end use by a consumer, such as a liquid, a gel, a powder, a bar, a tablet, a unitized dose article such as a pouch (single- or multi-compartmented), a fiber, a web, or a sheet.

The process may comprise the steps of: providing a concentrated surfactant composition as described herein and combining the concentrated surfactant composition with at least one adjunct to form a detergent composition.

The step of providing the concentrated surfactant composition may include the steps of preparing the concentrated surfactant composition at a first location and transporting the concentrated surfactant composition to a second location, and where the combining step occurs at the second location. The transporting may occur by rail car.

The concentrated surfactant compositions of the present disclosure are useful as surfactant intermediates that may be incorporated into different end-use detergent compositions. Therefore, the present disclosure relates to a process for manufacturing a plurality of detergent compositions, the process comprising the steps of: providing a first portion of the concentrated surfactant composition as described herein; combining the first portion with first detergent adjuncts to form a first detergent composition; providing a second portion of the concentrated surfactant composition as described herein; combining the second portion with second detergent adjuncts to form a second detergent composition that is compositionally different from the first detergent composition. For the processes described herein, the concentrated surfactant composition may be provided at a single batch and then divided in to first and second portions, but does not need to be. The first and second portions could be provided as separate batches, manufactured as separate places or separate times.

The second detergent composition may be different from the first detergent compositions in terms of the adjuncts added, the relative proportions in which the adjuncts and/or concentrated surfactant composition were added, pH, aesthetics (including color and/or perfume), or any other suitable compositional difference.

### Use of an Alkoxylated Polyalkyleneimine

The present disclosure further relates to the use of an alkoxylated polyalkyleneimine, preferably an alkoxylated PEI, for reducing viscosity of a concentrated surfactant composition, where the composition includes from about 60% to about 69%, by weight of the composition, of an alkyl alkoxylated sulfate surfactant.

### COMBINATIONS

Specifically contemplated combinations of the disclosure are herein described in the following lettered paragraphs. These combinations are intended to be illustrative in nature and are not intended to be limiting.

A. A concentrated surfactant composition consisting essentially of: from about 60% to about 69%, by weight of the composition of a surfactant system, wherein the surfactant system comprises from about 70% to about 100%, by weight of the surfactant system of an alkyl alkoxylated sulfate surfactant; from about 0.1% to about 5%, by weight of the composition, of an alkoxylated polyalkyleneimine; less than about 10%, preferably less than about 5%, by weight of the composition, of an organic solvent system; and water (and, optionally, an alkalizing agent).

B. A concentrated surfactant composition according to paragraph A, wherein the alkoxylated polyalkyleneimine comprises ethoxylate (EO) groups, propoxylate (PO) groups, or combinations thereof.

C. A concentrated surfactant composition according to any of paragraphs A-B, wherein the alkoxylated polyalkyleneimine comprises ethoxylate (EO) groups.

D. A concentrated surfactant composition according to any of paragraphs A-C, wherein the alkoxylated polyalkyleneimine comprises, on average per alkoxylated nitrogen, about 1-50 ethoxylate (EO) groups and about 0-5 propoxylate (PO) groups,

E. A concentrated surfactant composition according to any of paragraphs A-D, wherein the alkoxylated polyalkyleneimine comprises, on average per alkoxylated nitrogen, about 1-50 ethoxylate (EO) groups and is free of propoxylate (PO) groups.

F. A concentrated surfactant composition according to any of paragraphs A-E, wherein the alkoxylated polyalkyleneimine comprises, on average per alkoxylated nitrogen, about 10-30 ethoxylate (EO) groups, preferably about 15-25 ethoxylate (EO) groups.

G. A concentrated surfactant composition according to any of paragraphs A-F, wherein the alkoxylated polyalkyleneimine is an alkoxylated polyethyleneimine (PEI).

H. A concentrated composition according to any of paragraphs A-G, wherein the alkoxylated PEI comprises a polyethyleneimine backbone having a weight average molecular weight of from about 400 to about 1000, or from about 500 to about 750, or from about 550 to about 650, or about 600, as determined prior to ethoxylation.

I. A concentrated surfactant composition according to any of paragraphs A-H, wherein the alkoxylated PEI is present at a level of from about 0.5% to about 4.5%, preferably from about 0.75% to about 1.5%, by weight of the concentrated composition.

J. A concentrated surfactant composition according to any of paragraphs A-I, wherein the alkyl alkoxylated sulfate surfactant is alkyl ethoxylated surfactant, preferably having an average degree of ethoxylation of from about 1 to about 3.5, more preferably from about 1.5 to about 3, even more preferably from about 1.8 to about 2.5.

K. A concentrated surfactant composition according to any of paragraphs A-J, wherein the alkyl alkoxylated sulfate has an average alkyl chain length of from about 10 to about 16 carbon atoms, preferably from about 12 to about 15 carbon atoms, even more preferably from about 14 to about 15 carbon atoms.

L. A concentrated surfactant composition according to any of paragraphs A-K, wherein the alkyl alkoxylated sulfate surfactant is alkyl ethoxylated surfactant having an average alkyl chain length of from about 14 to about 15 carbon atoms, and an average degree of ethoxylation of from about 2.3 to about 2.7, preferably about 2.5.

M. A concentrated surfactant composition according to any of paragraphs A-L, wherein the surfactant system comprises from about 80%, or from about 90%, or from about 95%, to about 100%, by weight of the surfactant system, preferably about 100%, of the alkyl alkoxylated sulfate surfactant.

N. A concentrated surfactant composition according to any of paragraphs A-M, the composition comprising from about 10% to about 17%, preferably from about 12% to about 15%, by weight of the composition, of the organic solvent system.

O. A concentrated surfactant composition according to any of paragraphs A-N, wherein the organic solvent system comprises a solvent selected from the group consisting of: monohydric alcohols; dihydric alcohol; polyalkylene glycols; polyhydric alcohols; alkoxylated glycerine; alkoxylated diols; and combinations thereof.

P. A concentrated surfactant composition according to any of paragraphs A-O, wherein the organic solvent system comprises a solvent selected from the group consisting of: glycerine, ethanol, propanediol, diethylene glycol, dipropylene glycol, polyalkylene glycol, butanediol and combinations thereof.

Q. A concentrated surfactant composition according to any of paragraphs A-P, wherein the composition has a viscosity of less than about 20,000 cps, or from about 1000 to about 20,000 cps, or from about 3,000 to about 15,000 cps, or from about 4,000 to about 10,000 cps, or from about 5,000 to about 9,000 cps, when measured at 1 s⁻¹ at 40° C.

R. A concentrated surfactant composition according to any of paragraphs A-Q, wherein the composition remains as a single-phase solution after 2 weeks at 20° C., and/or 2 weeks at 40° C.

S. A concentrated surfactant composition according to any of paragraphs A-R, wherein the composition is substantially free of carboxylic acids and/or salts thereof, preferably substantially free of fatty acids and/or salts thereof.

T. A concentrated surfactant composition according to any of paragraphs A-S, wherein the composition is characterized by an alkaline pH, preferably a pH greater than 8, or greater than 9, or greater than 10, or greater than 11.

U. A concentrated surfactant composition according to any of paragraphs A-T, wherein the composition is characterized has having a reserve alkalinity of less than about 2, or less than about 1.5, or less than about 1, or less than about 0.8.

V. A concentrated surfactant composition according to any of paragraphs A-U, wherein the surfactant system further comprises from about 2% to about 20%, by weight of the composition, of anionic sulphonated surfactant, preferably alkyl benzene sulphonate surfactant, more preferably linear alkyl benzene sulphonate surfactant.

W. A detergent composition comprising the concentrated surfactant composition according to any of paragraphs A-V, and a detergent adjunct.

X. A detergent composition according to paragraph W, wherein the detergent adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

Y. A process for manufacturing a concentrated surfactant composition according to any of paragraphs A-V, the process comprising the steps of: providing a surfactant system, an alkoxylated polyalkyleneimine, an organic solvent system, and water; and combining the components in the following proportions to form the concentrated surfactant composition: from about 60% to about 69%, by weight of the composition, of surfactant system, wherein the surfactant system comprises from about 70% to about 100%, by weight of the surfactant system, of the alkyl alkoxylated sulfate surfactant; from about 0.1% to about 5%, by weight of the composition, of the alkoxylated polyalkyleneimine; from about 10% to about 20%, by weight of the composition, of the organic solvent system; and water.

Z. A process for manufacturing a detergent composition according to any of paragraphs W-X, the process comprising the steps of: providing a concentrated surfactant composition according to any of paragraphs A-V; and combining the concentrated surfactant composition with a detergent adjunct to form the detergent composition.

AA. A use of an alkoxylated polyalkyleneimine, e.g., as described in any of paragraphs A-V, preferably an alkoxylated PEI, for reducing viscosity of a concentrated surfactant composition, e.g., as described in any of paragraphs A-V, where the composition includes from about 60% to about 69%, by weight of the composition, of a surfactant system, where the surfactant system comprises from about 70%, or from about 80%, or from about 90%, or from about 95%, to about 100%, by weight of the surfactant system, of an alkyl alkoxylated sulfate surfactant.

### TEST METHODS

### Viscosity

The viscosity is measured with a Rheometer, such as the AR G2 Rheometer from TA Instruments. Viscosity is measured using 40 mm 2° cone at a range of temperatures between 10-60° C. Shear rates of 1 to 100 s⁻¹ are measured on a logarithmic scale with five points per decade.

### Percent Transmittance

The Percent Transmittance is measured with a UV-Visible spectrometer such as a Beckman Coulter DU® 800. A standard 10 mm pathlength cuvette is used for the sample measurement and compared to a deionized water blank. Samples are measured in the in the absence of dyes and/or opacifiers, and at a temperature of 20° C.±2° C.

pH

Unless otherwise stated herein, the pH of the composition is defined as the pH of an aqueous 10% (weight/volume) solution of the composition at 20±2° C. Any meter capable of measuring pH to ±0.01 pH units is suitable. Orion meters (Thermo Scientific, Clintinpark—Keppekouter, Ninovesteenweg 198, 9320 Erembodegem—Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution.

The 10% aqueous solution of the detergent is prepared according to the following procedure. A sample of 10±0.05 grams is weighted with a balance capable of accurately measuring to ±0.02 grams. The sample is transferred to a 100 mL volumetric flask, diluted to volume with purified water (deionized and/or distilled water are suitable as long as the conductivity of the water is <5 μS/cm), and thoroughly mixed. About 50 mL of the resulting solution is poured into a beaker, the temperature is adjusted to 20±2° C. and the pH is measured according to the standard procedure of the pH meter manufacturer. The manufacturer's instructions should be followed to set up and calibrate the pH assembly.

### Reserve Alkalinity

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve Alkalinity ( to pH 7.5 ) as \% alkali in g NaOH / 100 g product = \frac{T \times M \times 40 \times Vol}{10 \times Wt \times Aliquot}$$

titre (ml) to pH 7.5

Molarity of HCl=0.2

40=Molecular weight of NaOH

Vol=Total volume (ie. 1000 ml)

Wt=Weight of product (10 g)

Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate RA to pH 7.5.

### EXAMPLES

The examples provided below are intended to be illustrative in nature and are not intended to be limiting.

### Example 1. Process of Making a Concentrated Surfactant Composition

An ethoxylated alcohol is provided. The ethoxylated alcohol is sulfated by known processes to form alkyl ethoxylated sulfate surfactant. To this surfactant, the following are added in a neutralization loop while being mixed at high shear: organic solvent, ethoxylated PEI, water, and a neutralizing agent. Alternatively or additionally, the ethoxylated PEI may instead be added after the neutralization loop, with an additional high shear mixing step.

### Example 2. Viscosity Comparisons

As described below, various concentrated surfactant compositions were prepared and assessed for viscosity.

Sample Preparation

Each sample was prepared by mixing appropriate amounts of pre-neutralized Na-AES (70-78% active), pre-neutralized Na-LAS (78% active) where applicable, ethoxylated PEI (80% active), and water to balance in a speed mixing vessel to provide the compositions described below in Tables 1-3. The samples were then mixed in the speed mixer at 2400 rpm for two minutes. The samples were then transferred into a centrifuge and spun at 4400 rpm for one hour to remove excess air.

Viscosity.

The samples were measured for rheology on an ARG2 machine using a 113 μm initial gap and 63 μm test gap, 5 minute equilibrium time, and sheared from 1 to 100 s⁻¹ at various temperature points. Results are shown in Tables 1-3 below.

### Ingredients:

C24AE3S C12-14 alkyl ethoxy sulfate surfactant having an average of 3 ethoxy groups (sodium-neutralized)
C25AE1.8S C12-15 alkyl ethoxy sulfate surfactant having an average of 1.8 ethoxy groups (sodium-neutralized)
C45AE2.5S C14-15 alkyl ethoxy sulfate surfactant having an average of 2.5 ethoxy groups (sodium-neutralized)
LAS linear alkyl benzene sulphonate surfactant (sodium-neutralized)
PEI 1 Ethoxylated polyethyleneimine (PEI600 EO20, ex BASF)

TABLE 1

| | A (comp.) | B | C | D | E (comp.) |
|---|---|---|---|---|---|
| C24AE3S | 70% | 66% | 63% | — | 66% |
| C45AE2.5S | — | — | — | 65.7% | — |
| PEI 1 | 0% | 4.9% | 4.7% | 4.92 | 0% |
| Viscosity (Pa · s) | 29.1 | 9.5 | 4.7 | 14.1 | 28.2 |
| at 1.1 s⁻¹ (40° C.) | | | | | |

The results in Table 1 show the effect of an alkoxylated PEI on decreasing the low shear rheology of a concentrated AES composition. When the total amount of active ingredients are kept at approximately 70%, viscosity at about 1 s⁻¹ (40° C.) decreases about 70% in the compositions that include the alkoxylated PEI.

TABLE 2

| | A (comp.) | F | G | H | I (comp.) |
|---|---|---|---|---|---|
| C24AE3S | 70% | — | — | — | |
| C25AE1.8S | — | 51% | 53% | 55% | 53% |
| LAS | — | 12.75% | 13.25% | 13.81% | 13.25% |
| PEI 1 | 0% | 3.83% | 3.98% | 4.14% | 0% |
| Viscosity (Pa · s) | 29.1 | 8.9 | 10.8 | 17.1 | 28.9 |
| at 1 s⁻¹ (40° C.) | | | | | |

The results in Table 2 show the viscosity-lowering benefits of an alkoxylated PEI on concentrated surfactant compositions (active ingredients: approx. 70%) that include a mixture of surfactants (AES and LAS).

TABLE 3

| | J (comp.) | K |
|---|---|---|
| C45AE2.5S | 65.7% | 53% |
| LAS | — | 13.25% |
| PEI 1 | 4.92% | 3.98% |
| Viscosity (Pa · s) | 168.8 | 23.6 |
| at 1 s⁻¹ (20° C.) | | |
| Viscosity (Pa · s) | 14.2 | 13.8 |
| at 1 s⁻¹ (40° C.) | | |

The results in Table 3 show that a concentrated surfactant composition that includes AES, LAS, and an alkoxylated PEI has reduced viscosity at 20° C. compared to a similar composition that does not contain LAS. Without wishing to be bound by theory, it is believed that the combination of AES and LAS results in a reduced melt point of the composition, providing a composition that can more easily be processed due to the lower viscosity.

### Example 3. PEI Levels

A pre-neutralized surfactant composition containing 66% total surfactant (100% AES) is heated to 50° C. and then combined with an alkoxylated PEI polymer (PEI600 EO20, ex BASF) in varying amounts (from about 0% to about 6%) and water to balance. The samples are stirred using overhead agitation. The samples are then de-aerated by storing overnight to 60° C. Afterwards, the samples are analyzed for rheology using an ARG2 rheometer with a 40 cm 2° cone and plate geometry. Results for viscosity measured at 1 s⁻¹ at 40° C. vs. amount of PEI are shown below in Table 4.

TABLE 4

| | | Viscosity @ 1 s⁻¹ |
|---|---|---|
| No. | wt % PEI | at 40° C. (in Pa · s) |
| 1 (comp.) | 0.00 | 36.91 |
| 2 | 0.52 | 12.29 |
| 3 | 1.02 | 6.36 |
| 4 | 1.61 | 9.89 |
| 5 | 2.01 | 7.72 |
| 6 | 3.02 | 8.49 |
| 7 | 3.22 | 11.09 |
| 8 | 4.03 | 8.79 |
| 9 | 5.00 | 8.56 |
| 10 | 6.37 | 11.13 |

As shown by the results displayed in Table 4, a surfactant composition having approximately 0.5% of a PEI as described herein is characterized by significantly lower viscosity at 1 s⁻¹ at 40° C. compared to a similar composition that is free of a PEI. Additionally, the data shows that the optimum amount, from a rheology perspective, of PEI in the surfactant composition is about 1% PEI; adding more than about 1% PEI to the surfactant composition does not appear to significantly change the viscosity further under the given test conditions. That being said, more than 1% PEI may be desirable for improved performance in end-use cleaning compositions, such as a laundry detergent.

### Example 4. Surfactant Levels

Surfactant compositions are prepared according to Example 3, but in Example 4, the level of PEI is kept constant (about 1%), and the level of surfactant (AES) is varied. The viscosity results are shown in Table 5.

TABLE 5

| | | Viscosity @ 1 s⁻¹ |
|---|---|---|
| No. | wt % AES | at 40° C. (in Pa · s) |
| 1 | 62.99 | 6.0691 |
| 2 | 63.97 | 5.6888 |
| 3 | 64.98 | 7.7459 |
| 4 | 65.96 | 6.3635 |
| 5 | 67.01 | 9.4872 |
| 6 | 67.98 | 10.831 |
| 7 | 68.94 | 12.18 |

As can be seen by comparing the results in Table 5 to the comparative examples shown above (e.g., Table 1, comparative examples A and E), concentrated AES compositions having an alkoxylated PEI have lower viscosities at 1 s⁻¹ at 40° C. compared to compositions that do not include such alkoxylated PEIs. Further, as can be seen in the results displayed in Table 5, compositions having from about 63% to about 66% AES and an alkoxylated PEI show particularly favorable (i.e., low) viscosities, especially compositions having about 64% AES.

### Example 5. Heavy Duty Liquid Laundry Detergent Compositions

Concentrated surfactant compositions according to the present disclosure are used to make heavy duty liquid laundry detergent compositions according to the following formulas, as shown in Table 6.

TABLE 6

| | A | B | C | D | E | F | G | H |
|---|---|---|---|---|---|---|---|---|
| Ingredient | (wt %) | (wt %) | (wt %) | (wt %) | (wt %) | (wt %) | (wt %) | (wt %) |
| AES | 15 | 11 | 10 | 7 | 22 | 11 | 30 | 1.2 |
| LAS | 9 | 4 | 3 | 2 | 10 | 11 | 6 | 9 |
| HSAS | 0 | 3 | 0 | 0 | 0 | 0 | 0 | 0 |
| AE | 4 | 0 | 3 | 0 | 5 | 2 | 4 | 5 |
| Lauryl Trimethyl Ammonium | 0 | 0 | 0 | 0 | 0.3 | 0 | 0 | 0 |
| Chloride | | | | | | | | |
| C₁₂₋₁₄ dimethyl Amine Oxide | 0.8 | 0.7 | 0.3 | 0.5 | 0 | 0 | 0 | 0 |
| Citric Acid | 2.5 | 4.0 | 1.9 | 2.0 | 0.9 | 2.5 | 0.6 | 1.2 |
| C₁₂₋₁₈ Fatty Acid | 0.8 | 3.5 | 0.6 | 0.99 | 1.2 | 0 | 15.0 | 2.5 |
| Chelant | 0.3 | 0.15 | 0.11 | 0.07 | 0.5 | 0.11 | 0.8 | 0.4 |
| Sodium Formate | 1.6 | 0.1 | 1.2 | 0 | 1.6 | 0 | 0.2 | 0.2 |
| Calcium Formate | 0.1 | 0 | 0 | 0.04 | 0 | 0.13 | 0 | 0.1 |
| Calcium Chloride | 0.01 | 0.08 | 0 | 0 | 0 | 0 | 0 | 0 |
| Magnesium Chloride | 0 | 0 | 0 | 0 | 0.02 | 0.04 | 0 | 0 |
| Mannanase: Mannaway ® (25 mg | 0.002 | 0.05 | 0 | 0.06 | 0.04 | 0.045 | 0.1 | 0.1 |
| active/g) | | | | | | | | |
| Protease (40.6 mg active/g) | 0.8 | 0.6 | 0.07 | 0 | 0.7 | 0.2 | 1.5 | 0.5 |
| Amylase: Stainzyme ® (15 mg | 0.3 | 0 | 0.3 | 0.02 | 0 | 0.6 | 0.1 | 0.14 |
| active/g) | | | | | | | | |
| Amylase: Natalase ® (29 mg | 0 | 0.6 | 0.1 | 0.15 | 0.07 | 0 | 0.1 | 0 |
| active/g) | | | | | | | | |
| Xyloglucanase (Whitezyme ®, 20 mg | 0.2 | 0.1 | 0 | 0 | 0.01 | 0.05 | 0.2 | 0 |
| active/g) | | | | | | | | |
| Lipex ® (18 mg active/g) | 0.4 | 0.2 | 0.3 | 0.1 | 0.2 | 0 | 0 | 0 |
| 4-formyl-phenylboronic acid | 0 | 0 | 0 | 0 | 0.1 | 0.02 | 0.01 | 0 |
| Borax | 1.5 | 2.1 | 1.1 | 0.8 | 0 | 1.0 | 0 | 1.3 |
| Ethoxylated Polyethylenimine | 0.3 | 0.2 | 0.2 | 0.4 | 0.4 | 0.2 | 0.8 | 2.2 |
| Grease Cleaning Alkoxylated | 1 | 2 | 0 | 0 | 1.5 | 0 | 0 | 0 |
| Polyalkylenimine Polymer | | | | | | | | |
| PEG-PVAc Polymer | 0.1 | 0.2 | 0.0 | 4 | 0.05 | 0.0 | 1 | 0 |
| Zwitterionic ethoxylated | 2.1 | 0 | 0.7 | 1.6 | 0.3 | 1.6 | 0 | 0 |
| quaternized sulfated hexamethylene | | | | | | | | |
| diamine | | | | | | | | |
| Fluorescent Brightener | 0.2 | 0.1 | 0.05 | 0.3 | 0 | 0.3 | 0.2 | 0.2 |
| Diethylene glycol | 4.5 | 0 | 3.6 | 0 | 3.0 | 0 | 0 | 0 |
| Ethanol | 2.5 | 2.0 | 1.7 | 1.1 | 3.5 | 3.0 | 7.0 | 1 |
| 1,2-Propanediol | 0 | 6.6 | 0 | 1.2 | 3.0 | 2.0 | 8.0 | 2.5 |
| Monoethanolamine | 1.4 | 1.0 | 4.0 | 0.5 | 0 | 0 | To pH 8.2 | 0 |
| Cumene sulfonate | 0.0 | 0.2 | 0.5 | 1 | 2 | 0 | 0 | 1.35 |
| Sodium Hydroxide | 0.8 | 0.4 | 0.5 | 0.4 | 0.3 | 0.1 | 0.1 | To pH 8.2 |
| Hydrogenated castor oil derivative | 0.1 | 0 | 0.4 | 0 | 0 | 0 | 0.1 | 0.15 |
| structurant | | | | | | | | |
| Suds Suppressor | 0.2 | 0 | 0.1 | 0.4 | 0 | 0 | 0 | 0 |
| Perfume | 1.6 | 1.1 | 1.0 | 0.1 | 0.9 | 1.5 | 1.6 | 0.4 |
| Core Shell Melamine-formaldehyde | 0.5 | 0.05 | 0.00 | 0.02 | 0.1 | 0.05 | 0.1 | 0.15 |
| encapsulate of perfume | | | | | | | | |
| Hueing Agent | 0.05 | 0.00 | 0.00 | 0.00 | 0.0 | 0.025 | 0 | 0 |

| | |
|---|---|
| *Water, dyes & minors | Balance |

*Based on total cleaning and/or treatment composition weight
All enzyme levels are expressed as % enzyme raw material.

### Raw Materials for Example 5

LAS is linear alkylbenzenesulfonate having an average aliphatic carbon chain length C₁₁-C₁₂ supplied by Stepan, Northfield, Ill., USA or Huntsman Corp. HLAS is acid form.
AES is C₁₂₋₁₄ alkyl ethoxy (3) sulfate, C₁₂₋₁₅ alkyl ethoxy (1.8) sulfate, or C₁₄₋₁₅ alkyl ethoxy (2.5) sulfate supplied by Stepan, Northfield, Ill., USA or Shell Chemicals, Houston, Tex., USA.
AE is selected from C₁₂₋₁₃ with an average degree of ethoxylation of 6.5, C₁₁₋₁₆ with an average degree of ethoxylation of 7, C₁₂₋₁₄ with an average degree of ethoxylation of 7, C₁₄₋₁₅ with an average degree of ethoxylation of 7, or C₁₂₋₁₄ with an average degree of ethoxylation of 9, all supplied by Huntsman, Salt Lake City, Utah, USA.
AS is a C₁₂₋₁₄ sulfate, supplied by Stepan, Northfield, Ill., USA.
HSAS is mid-branched alkyl sulfate as disclosed in U.S. Pat. No. 6,020,303 and U.S. Pat. No. 6,060,443.
C₁₂₋₁₄ Dimethylhydroxyethyl ammonium chloride, supplied by Clamant GmbH, Germany.
C₁₂₋₁₄ dimethyl Amine Oxide is supplied by Procter & Gamble Chemicals, Cincinnati, USA.
Sodium tripolyphosphate is supplied by Rhodia, Paris, France.
Zeolite A is supplied by Industrial Zeolite (UK) Ltd, Grays, Essex, UK.
1.6R Silicate is supplied by Koma, Nestemica, Czech Republic.
Sodium Carbonate is supplied by Solvay, Houston, Tex., USA.
Acrylic Acid/Maleic Acid Copolymer is molecular weight 70,000 and acrylate:maleate ratio 70:30, supplied by BASF, Ludwigshafen, Germany.
PEG-PVAc polymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. Available from BASF (Ludwigshafen, Germany).
Ethoxylated Polyethylenimine is a 600 g/mol molecular weight polyethylenimine core with 20 ethoxylate groups per —NH. Available from BASF (Ludwigshafen, Germany).
Zwitterionic ethoxylated quaternized sulfated hexamethylene diamine is described in WO 01/05874 and available from BASF (Ludwigshafen, Germany).
Grease Cleaning Alkoxylated Polyalkylenimine Polymer is a 600 g/mol molecular weight polyethylenimine core with 24 ethoxylate groups per —NH and 16 propoxylate groups per —NH. Available from BASF (Ludwigshafen, Germany).
Carboxymethyl cellulose is Finnfix® V supplied by CP Kelco, Arnhem, Netherlands.
Amylases (Natalase®, Stainzyme®, Stainzyme Plus®) may be supplied by Novozymes, Bagsvaerd, Denmark.
Savinase®, Lipex®, Celluclean™, Mannaway®, Pectawash®, and Whitezyme® are all products of Novozymes, Bagsvaerd, Denmark.
Proteases may be supplied by Genencor International, Palo Alto, Calif., USA (e.g. Purafect Prime®) or by Novozymes, Bagsvaerd, Denmark (e.g. Liquanase®, Coronase®).
Suitable Fluorescent Whitening Agents are for example, Tinopal® TAS, Tinopal® AMS, Tinopal® CBS-X, Sulphonated zinc phthalocyanine, available from BASF, Ludwigshafen, Germany.
Chelant is selected from, diethylenetetraamine pentaacetic acid (DTPA) supplied by Dow Chemical, Midland, Mich., USA, hydroxyethane di phosphonate (HEDP) supplied by Solutia, St Louis, Mo., USA; Ethylenediamine-N,N′-disuccinic acid, (S,S) isomer (EDDS) supplied by Octel, Ellesmere Port, UK, Diethylenetriamine penta methylene phosphonic acid (DTPMP) supplied by Thermphos, or 1,2-dihydroxybenzene-3,5-disulfonic acid supplied by Future Fuels Batesville, Ark., USA
Hueing agent is Direct Violet 9 or Direct Violet 99, supplied by BASF, Ludwigshafen, Germany.
Soil release agent is Repel-o-tex® PF, supplied by Rhodia, Paris, France.
Suds suppressor agglomerate is supplied by Dow Corning, Midland, Mich., USA
Acusol 880 is supplied by Dow Chemical, Midland, Mich., USA
TAED is tetraacetylethylenediamine, supplied under the Peractive® brand name by Clariant GmbH, Sulzbach, Germany.
Sodium Percarbonate supplied by Solvay, Houston, Tex., USA.
NOBS is sodium nonanoyloxybenzenesulfonate, supplied by Future Fuels, Batesville, Ark., USA.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A concentrated surfactant composition consisting essentially of:
from about 60% to about 69%, by weight of the composition of a surfactant system, wherein the surfactant system comprises from about 70% to about 100%, by weight of the surfactant system of an alkyl alkoxylated sulfate surfactant;
from about 0.1% to about 5%, by weight of the composition, of an alkoxylated polyalkyleneimine;
less than about 10%, preferably less than about 5%, by weight of the composition, of an organic solvent system; and
water.

2. A concentrated surfactant composition according to claim 1, wherein the alkoxylated polyalkyleneimine comprises ethoxylate (EO) groups, propoxylate (PO) groups, or combinations thereof.

3. A concentrated surfactant composition according to claim 1, wherein the alkoxylated polyalkyleneimine comprises ethoxylate (EO) groups.

4. A concentrated surfactant composition according to claim 1, wherein the alkoxylated polyalkyleneimine comprises, on average per alkoxylated nitrogen, about 1-50 ethoxylate (EO) groups and about 0-5 propoxylate (PO) groups,

5. A concentrated surfactant composition according to claim 4, wherein the alkoxylated polyalkyleneimine comprises, on average per alkoxylated nitrogen, about 1-50 ethoxylate (EO) groups and is free of propoxylate (PO) groups.

6. A concentrated surfactant composition according to claim 4, wherein the alkoxylated polyalkyleneimine comprises, on average per alkoxylated nitrogen, about 10-30 ethoxylate (EO) groups, preferably about 15-25 ethoxylate (EO) groups.

7. A concentrated surfactant composition according to claim 1, wherein the alkoxylated polyalkyleneimine is an alkoxylated polyethyleneimine (PEI).

8. A concentrated composition according to claim 1, wherein the alkoxylated PEI comprises a polyethyleneimine backbone having a weight average molecular weight of from about 400 to about 1000, or from about 500 to about 750, or from about 550 to about 650, or about 600, as determined prior to ethoxylation.

9. A concentrated surfactant composition according to claim 1, wherein the alkoxylated PEI is present at a level of from about 0.5% to about 4.5%, preferably from about 0.75% to about 1.5%, by weight of the concentrated composition.

10. A concentrated surfactant composition according to claim 1, wherein the alkyl alkoxylated sulfate surfactant is alkyl ethoxylated surfactant, preferably having an average degree of ethoxylation of from about 1 to about 3.5, more preferably from about 1.5 to about 3, even more preferably from about 1.8 to about 2.5.

11. A concentrated surfactant composition according to claim 1, wherein the alkyl alkoxylated sulfate has an average alkyl chain length of from about 10 to about 16 carbon atoms, preferably from about 12 to about 15 carbon atoms, even more preferably from about 14 to about 15 carbon atoms.

12. A concentrated surfactant composition according to claim 1, wherein the alkyl alkoxylated sulfate surfactant is alkyl ethoxylated surfactant having an average alkyl chain length of from about 14 to about 15 carbon atoms, and an average degree of ethoxylation of from about 2.3 to about 2.7, preferably about 2.5.

13. A concentrated surfactant composition according to claim 1, wherein the surfactant system comprises from about 80%, or from about 90%, or from about 95%, to about 100%, by weight of the surfactant system, preferably about 100%, of the alkyl alkoxylated sulfate surfactant.

14. A concentrated surfactant composition according to claim 1, the composition comprising from about 10% to about 17%, preferably from about 12% to about 15%, by weight of the composition, of the organic solvent system.

15. A concentrated surfactant composition according to claim 1, wherein the organic solvent system comprises a solvent selected from the group consisting of: monohydric alcohols; dihydric alcohol; polyalkylene glycols; polyhydric alcohols; alkoxylated glycerine; alkoxylated diols; and
combinations thereof.

16. A concentrated surfactant composition according to claim 1, wherein the organic solvent system comprises a solvent selected from the group consisting of: glycerine, ethanol, propanediol, diethylene glycol, dipropylene glycol, polyalkylene glycol, butanediol and combinations thereof.

17. A concentrated surfactant composition according to claim 1, wherein the composition has a viscosity of less than about 20,000 cps, or from about 1000 to about 20,000 cps, or from about 3,000 to about 15,000 cps, or from about 4,000 to about 10,000 cps, or from about 5,000 to about 9,000 cps, when measured at 1 s⁻¹ at 40° C.

18. A concentrated surfactant composition according to claim 1, wherein the composition remains as a single-phase solution after 2 weeks at 20° C., and/or 2 weeks at 40° C.

19. A concentrated surfactant composition according to claim 1, wherein the composition is substantially free of carboxylic acids and/or salts thereof, preferably substantially free of fatty acids and/or salts thereof.

20. A concentrated surfactant composition according to claim 1, wherein the composition is characterized by an alkaline pH, preferably a pH greater than 8, or greater than 9, or greater than 10, or greater than 11.

21. A concentrated surfactant composition according to claim 1, wherein the composition is characterized has having a reserve alkalinity of less than about 2, or less than about 1.5, or less than about 1, or less than about 0.8.

22. A concentrated surfactant composition according to claim 1, wherein the surfactant system further comprises from about 2% to about 20%, by weight of the composition, of anionic sulphonated surfactant, preferably alkyl benzene sulphonate surfactant, more preferably linear alkyl benzene sulphonate surfactant.

23. A detergent composition comprising the concentrated surfactant composition according to claim 1, and a detergent adjunct.

24. A detergent composition according to claim 22, wherein the detergent adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

25. A process for manufacturing a concentrated surfactant composition, the process comprising the steps of:
providing a surfactant system, an alkoxylated polyalkyleneimine, an organic solvent system, and water; and
combining the components in the following proportions to form the concentrated surfactant composition:
from about 60% to about 69%, by weight of the composition, of surfactant system, wherein the surfactant system comprises from about 70% to about 100%, by weight of the surfactant system, of the alkyl alkoxylated sulfate surfactant;
from about 0.1% to about 5%, by weight of the composition, of the alkoxylated polyalkyleneimine;
from about 10% to about 20%, by weight of the composition, of the organic solvent system; and
water.

26. A process for manufacturing a detergent composition, the process comprising the steps of:
providing a concentrated surfactant composition according to claim 1; and
combining the concentrated surfactant composition with a detergent adjunct to form the detergent composition.

27. A use of an alkoxylated polyalkyleneimine, preferably an alkoxylated PEI, for reducing viscosity of a concentrated surfactant composition, where the composition includes from about 60% to about 69%, by weight of the composition, of a surfactant system, where the surfactant system comprises from about 70%, or from about 80%, or from about 90%, or from about 95%, to about 100%, by weight of the surfactant system, of an alkyl alkoxylated sulfate surfactant.
